(19) United States
(12) Patent Application Publication
(10) Pub. No.: US 2026/0220335 A1
(43) Pub. Date: Jul. 30, 2026

(54) SYNTHETIC WAFER GENERATION

(71) Applicant: Advanced Micro Devices, Inc., Santa Clara, CA (US)

(72) Inventors: Zachary EICH, Austin, TX (US); Casey Dwyane SCOTT, Austin, TX (US); Ying Hao TAN, Singapore (SG); Milad RAD, Buda, TX (US)

(21) Appl. No.: 19/040,714

(22) Filed: Jan. 29, 2025

(51) Int. Cl. G06F 30/27; H10P 72/00; H10P 74/20; G06F 119/02

(52) U.S. Cl. CPC G06F 30/27; H10P 72/0606; H10P 74/203; G06F 2119/02

(57) ABSTRACT

Synthetic wafer generation based on a multi-tiered ML model that includes a technology-level ML model that infers coordinate-based wafer-level characteristics of a synthetic wafer model, and a product-level ML model that infers coordinate-based die-level characteristics of the synthetic wafer model based on the inferred coordinate-based wafer-level characteristics, a design of dies of the synthetic wafer model, and coordinates of the dies. The multi-tiered ML model may be trained based on sparse training data using a combinations of supervised learning and generative learning methods, which may include a tabular variational autoencoder using metric learning (TVAE) method, a conditional tabular generative adversarial network (CTGAN) method, Gaussian Copulas, and/or K-nearest neighbor method. Wafer-level training characteristics may be converted from a coordinate system of a test probe to wafer coordinates (e.g., polar coordinates).

### TECHNICAL FIELD

Examples of the present disclosure generally relate to synthetic wafer generation using TVAES, CTGANS, and Gaussian Copulas.

### BACKGROUND

In electronics, a wafer is a thin slice of a semiconductor material that serves as a substrate for integrated circuit devices (i.e. dies) fabricated on the wafer. Fabrication may include doping, ion implantation, etching, thin-film deposition of various materials, and photolithographic patterning. The wafer is then cut or diced along spaces (i.e., scribe lines) between the dies to separate the dies from one another. The dies may be packaged as respective integrated circuit devices. The wafer and/or the dies may be tested or characterized at various stages of fabrication. The dies may be further tested after dicing.

Wafer testing may be useful for acceptance determination, yield determination, product definition (e.g., determining responses to different test conditions, setting power and/or limits of the dies, etc.), and/or binning. In order to produce an accurate representation or model of a product (i.e., dies), product definition should be based on a sufficient number of sample wafers to accurately represent a production population. In some situations, cost and/or time constraints may make it impractical to obtain a sufficient number of sample wafers, which makes it challenging to accurately model responses.

### SUMMARY

Techniques for synthetic wafer generation are described. One example is an apparatus that includes a processor and memory encoded with instructions to cause the processor to: receive wafer-level training characteristics for a first set of physical training wafers; receive coordinates of wafer test sites from which the wafer-level training characteristics are obtained; convert the coordinates of the wafer-level training characteristics from a coordinate system of a test probe to a wafer-based coordinate system; train a technology-level machine learning (ML) model to infer the wafer-level training characteristics based on the converted coordinates; use the technology-level ML model to infer coordinate-based wafer-level characteristics of a second set of physical training wafers; receive sparse coordinate-based die-level training characteristics for dies of the second set of physical wafer models, where the sparse coordinate-based die-level training characteristics comprise die-level training characteristics for a subset of the dies of the second set of physical wafer models; and train a product-level ML model to infer the sparse coordinate-based die-level training characteristics of the subset of dies of the second set of physical training wafer models and to infer coordinate-based die-level training characteristics for other dies of the second set of physical training wafers, based on the inferred coordinate-based wafer-level characteristics of the second set of physical training wafers, a design of the dies of the second set of physical training wafers, and coordinates of the dies of the second set of physical training wafers.

Another example described herein is a computer program that includes instructions to cause a processor to infer coordinate-based wafer-level characteristics of a synthetic wafer model based on features of the synthetic wafer model and a technology-level machine-learning (ML) model, and infer coordinate-based die-level characteristics of the synthetic wafer model based on the inferred wafer-level characteristics of the synthetic wafer model, a design of dies of the synthetic wafer model, and a product-level ML model, where one or more of the technology-level ML model and the product-level ML model is trained based on sparse training data based in part on a generative training method.

Another example described herein is a method that includes: receiving wafer-level training characteristics for a first set of physical training wafers; receiving coordinates of wafer test sites from which the wafer-level training characteristics are obtained; converting the coordinates of the wafer-level training characteristics from a coordinate system of a test probe to a wafer-based coordinate system; training a technology-level machine learning (ML) model to infer the wafer-level training characteristics based on the converted coordinates; using the technology-level ML model to infer coordinate-based wafer-level characteristics of a second set of physical training wafers; receiving sparse coordinate-based die-level training characteristics for dies of the second set of physical wafer models, wherein the sparse coordinate-based die-level training characteristics comprise die-level training characteristics for a subset of the dies of the second set of physical wafer models; and training a product-level ML model to infer the sparse coordinate-based die-level training characteristics of the subset of dies of the second set of physical training wafer models and to infer coordinate-based die-level training characteristics for other dies of the second set of physical training wafers, based on the inferred coordinate-based wafer-level characteristics of the second set of physical training wafers, a design of the dies of the second set of physical training wafers, and coordinates of the dies of the second set of physical training wafers.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a system that predicts or infers coordinate-based die/product-level wafer characteristics of a wafer model based on a multi-tiered machine learning (ML) model, according to an embodiment.

FIG. 2A depicts a training wafer model of a first set of training wafers, according to an embodiment.

FIG. 2B depicts a training wafer model of a second set of training wafers, according to an embodiment.

FIG. 3 depicts a technology-level ML model of the multi-tiered ML model in a training mode, according to an embodiment.

FIG. 4 depicts the technology-level ML model in an inference mode and a product-level ML model of the multi-tiered ML model in a training mode, according to an embodiment.

FIG. 5 depicts the multi-tiered ML model in an inference mode, according to an embodiment.

FIG. 6 depicts a method of training and using the multi-tiered machine learning (ML) model, according to an embodiment.

FIG. 7 depicts a table of wafer-level and die-level characteristics, according to an embodiment.

FIG. 8 depicts a multi-dimensional plot of coordinate-based die-level characteristics for dies of synthetic wafers, according to an embodiment.

FIG. 9A depicts 2-dimensional plots (i.e., clouds) of coordinate-based die-level characteristics for dies of synthetic wafers, according to an embodiment.

FIG. 9B depicts 2-dimensional plots (i.e., clouds) of coordinate-based die-level characteristics for dies of synthetic wafers, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe synthetic wafer generation. In an example, synthetic wafer generation is based on a multi-tiered machine-learning (ML) approach that includes a technology-level ML model and a product-level (i.e., die-level) ML model.

The technology-level ML model is trained to infer wafer-level training characteristics (e.g., wafer acceptance test data) obtained from physical wafers, based on coordinates of corresponding test sites. The physical wafers may include physical wafers of the same wafer model (i.e., same die design and wafer layout), and/or physical wafers that differ from one another. The physical wafers may include physical wafers of the same fabrication technology (e.g., a 2 nanometer fabrication technology).

The wafer-level training characteristics for the technology-level ML model may be obtained from a fabrication facility, an outsourced semiconductor assembly and test (OSAT) facility, an internal test facility, and/or other source(s), and may include characterization data from wafer acceptance tests (WATs), wafer probes, wafer sort tests, and/or other tests. The wafer-level training characteristics may be obtained from structures within scribe lines of the physical wafers.

Coordinates of the wafer-level test sites may be converted from a coordinate system of wafer-level testing to wafer-based coordinates (e.g., polar coordinates), prior to training the technology-level ML model. The technology-level ML model may be used to infer wafer-level coordinates of a wafer model that includes dies of a first design, for use in training the product-level ML model.

The product-level ML model is trained to infer die-level characteristics of a wafer model based on a design of dies of the wafer model, sparse die-level training characteristics obtained from (e.g., relatively few) physical samples of the wafer model, and the inferred wafer-level characteristics of the wafer model provided by the technology-level ML model. Training data for the product-level ML model (i.e., die-level characteristics) may be obtained from an OSAT and/or an internal test facility.

The sparse die-level training characteristics may include die-level characteristics for a subset of the dies of the wafer model. Remaining dies of the wafer model may lack die-level training characteristics due to testing faults and/or other factors. The product-level ML model may be trained to infer the sparse die-level training characteristics of the subset of dies based on a supervised training method(s), and may determine die-level characteristics for the remaining dies of the wafer model based on a generative method(s).

Once trained, the technology-level and product-level ML models may be used in conjunction with one another to infer die-level characteristics of other wafer models (e.g., for the fabrication technology), such as to generatesynthetic wafers. Training and using the technology-level and product-level ML models in conjunction with one another may be useful to capture and maintain relationships/variances amongst wafer-level and die-level characteristics

The wafer-level training characteristics...coordinate system...

A ML model training system may train the technology-level ML model and/or the product-level ML model based on one or more of a variety of machine learning methods, including supervised machine learning methods. In an example, the ML model training platform trains the technology-level ML model and/or the product-level ML model based on one or more of Tabular Variational Autoencoder using Metric Learning (TVAE), Conditional Tabular Generative Adversarial Network (CTGAN), and/or Gaussian Copulas.

TVAE is framework to learn latent embedding in variational autoencoder (VAE) by incorporating deep metric learning. Deep metric learning is useful for learning semantic representation and encoding information that can be used to measure data similarity, by relying on the embedding learned from metric learning. VAE is useful to approximate inference for directed probabilistic models. For traditional VAE, however, the data label or feature information are intractable. Similarly, traditional representation learning approaches fail to represent many salient aspects of the data. With TVAE, features are learned by optimizing a triplet loss on the mean vectors of VAE in conjunction with standard evidence lower bound (ELBO) of VAE. TVAE captures more fine-grained information in the latent embedding.

CT-GAN is a collection of deep learning-based synthetic data generators for single table data, which are able to learn from real data and generate synthetic data with high fidelity.

A copula is a classical approach for capturing the dependence between random variables. A Gaussian copula maps the marginal distribution of each variable to the standard normal distribution which, by definition, has a mean of zero and a standard deviation of one. Copula correlation models create a joint probability distribution for two or more variables while still preserving their marginal distributions.

Synthetic wafer generation may be useful to model one or more of a variety of characteristics (e.g., ones, tens, hundreds, thousands, and/or tens of thousands of characteristics), including power and/or timing characteristics.

Synthetic wafer generation may be useful to model variations in characteristics across synthetic wafers and/or to model spatial variations in characteristics across a synthetic wafer.

Synthetic wafer generation may be useful to leverage wafer-level characteristics of other products (e.g., physical wafers of a given fabrication technology, having differing die designs).

Synthetic wafer generation may be useful for generating reliable characterization data to provide a better understanding of how a product will perform, and to make better assumptions for product definitions.

Synthetic wafer generation may be useful to determine characteristics of proposed/contemplated a product.

Synthetic wafer generation may be useful to determine die-level characteristics of a proposed product for different fabrication targets.

Synthetic wafer generation may be useful to select one of multiple wafer models based on corresponding die-level characteristics.

Synthetic wafer generation may be useful to reduce costs and/or turn-around time in product definition. Uses of synthetic wafer generation is not, however, limited to product definition.

Synthetic wafer generation may be useful for representing dies of multiple instances of a synthetic wafer model (e.g., tens of thousands or hundreds of thousands of dies) in a multi-dimensional space based on inferred coordinate-based die-level characteristics of the dies. The representation may be rendered or mapped to a 2-dimensional space, which may appear as a circular and/or oval-shaped cloud. The visual representation may be overlaid with bounding boxes that encompass dies that meet respective product definitions. The product definitions may be associated with respective ordering part numbers (OPNs). The bounding boxes may represent bins into which physical embodiments of respective dies would be assigned. The number of dies within the bounding box may represent yields for the respective OPNs. The number of dies within a bounding box may be altered by altering the synthetic wafer model, and/or boundaries of the bounding box may be altered to meet a criterion. The visual depictions may be useful to identify percentages of the dies that meet a product definition (i.e., yield). The visual depiction may represent a performance distribution.

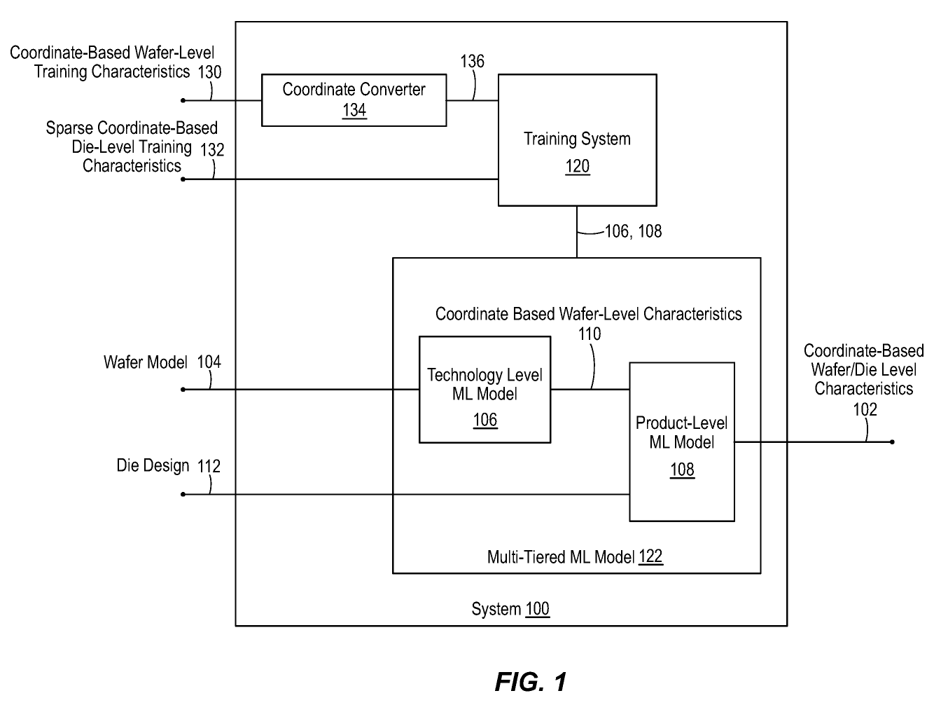

FIG. 1 depicts a system 100 that includes a multi-tiered ML model 122 that predicts or infers coordinate-based characteristics 102 of a wafer model 104, according to an embodiment. Coordinate-based characteristics 102 may include wafer-level characteristics and/or die-level characteristics. System 100 may include a processor and memory encoded with instructions for execution by the processor. Alternatively, or additionally, system 100 may include circuitry, such as fixed/hardened logic, programmable logic, and/or accelerator logic.

In the example of FIG. 1, ML model 122 includes a technology-level ML model 106 and a product-level ML model 108. Technology-level ML model 106 infers coordinate-based wafer-level characteristics 110 (i.e., technology-based wafer-level characteristics) of wafer model 104. Product-level ML model 108 infers coordinate-based characteristics 102 based a circuit design 112 of dies of wafer model 104 and inferred coordinate-based wafer-level characteristics 110.

System 100 may further include a training system 120 that trains model 122 based on coordinate-based wafer-level training data 130 and coordinate-based sparse die-level training data 132. System 100 may further include a coordinate converter 134 that converts coordinates of coordinate-based wafer level-training data 130 from a coordinate system of coordinate-based wafer level-training data 130 to wafer-based coordinate system (e.g., a polar coordinate system), to provide converted coordinate-based wafer-level training data 136.

Coordinate-based wafer-level training data 130 may be obtained from a first set of physical training wafers, and coordinate-based sparse die-level training data 132 may be obtained from a second set of physical training data. The first set of physical training wafers may include dies of various circuit designs, which may be unrelated to die design 112. The second set of training wafers may include dies of similar circuit designs to die design 112. The dies of the second set of training wafers may, for example, represent variations of die design 112. The first and second set of physical training wafers, and wafer model 104 may be fabricated based on the process technology (e.g., 2nm, 5nm, 7nm, and/or other technology).

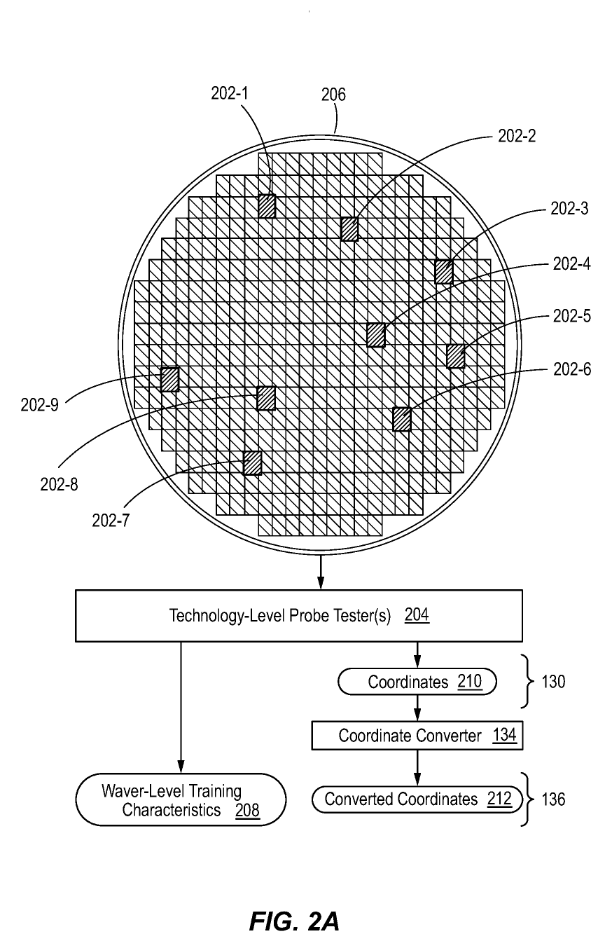

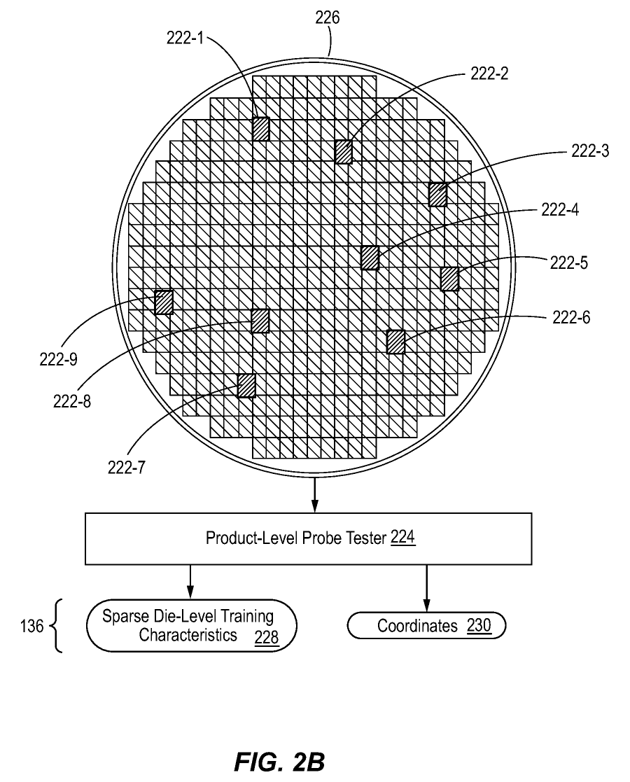

FIG. 2A depicts a training wafer model 206 of the first set of training wafers, according to an embodiment. Wafer-level characteristics of wafer model 206 may vary across wafer model 206. As an example, wafer-level characteristics near outer edges of wafer model 206 may differ from wafer-level characteristics within a central region of wafer model 206.

To capture such spatial variations, FIG. 2A further depicts a technology-level probe tester(s) 204 that captures wafer-level training characteristics 208 at various test sites 202-1 through 202-9, and corresponding test site coordinates 210 (collectively, coordinate-based wafer-level training characteristics 130). Wafer-level training characteristics 208 may include, for example and without limitation, characteristics of scribe line structures. Technology-level probe tester(s) 204 may capture wafer-level training characteristics 208 as part of waver acceptance tests (WATs), wafer sort tests, and/or other tests. As described further above, coordinate converter 134 converts test site coordinates 210 of wafer-level test sites 202 from a coordinate system of technology-level probe tester(s) 204 to wafer-based coordinates (e.g., polar coordinates), depicted here as converted coordinates 212.

FIG. 2B depicts a training wafer model 226 of the second set of training wafers, according to an embodiment. Die-level characteristics of wafer model 226 may vary across wafer model 226 (e.g., core to core variances and/or characteristic shifts). As an example, die-level characteristics near outer edges of wafer model 226 may differ from die-level characteristics within a central region of wafer model 226. To capture such spatial variations, FIG. 2B further depicts a die or product-level probe tester(s) 224 that captures die-level characteristics from multiple dies of wafer model 226. Product-level probe tester(s) 224 may capture, for example and without limitation, power characteristics (e.g., minimum/maximum operating voltages), timing characteristics (e.g., minimum/maximum operating frequencies), functional characteristics, leakage currents, and/or saturation currents.

In some situations, product-level probe tester(s) 224 may not capture die-level characteristics from all dies of wafer model 226, due to test failures and/or other factors. In such situations, product-level probe tester(s) 224 provides sparse die-level training characteristics 228 and corresponding coordinates 230 (collectively, sparse coordinate-based die-level training characteristics136).

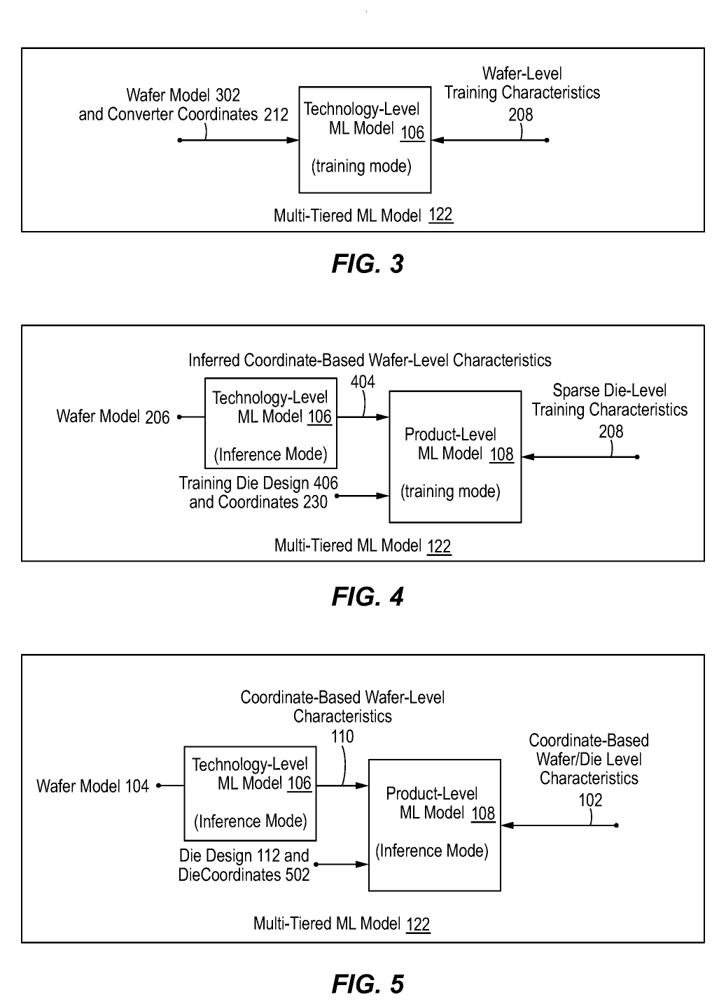

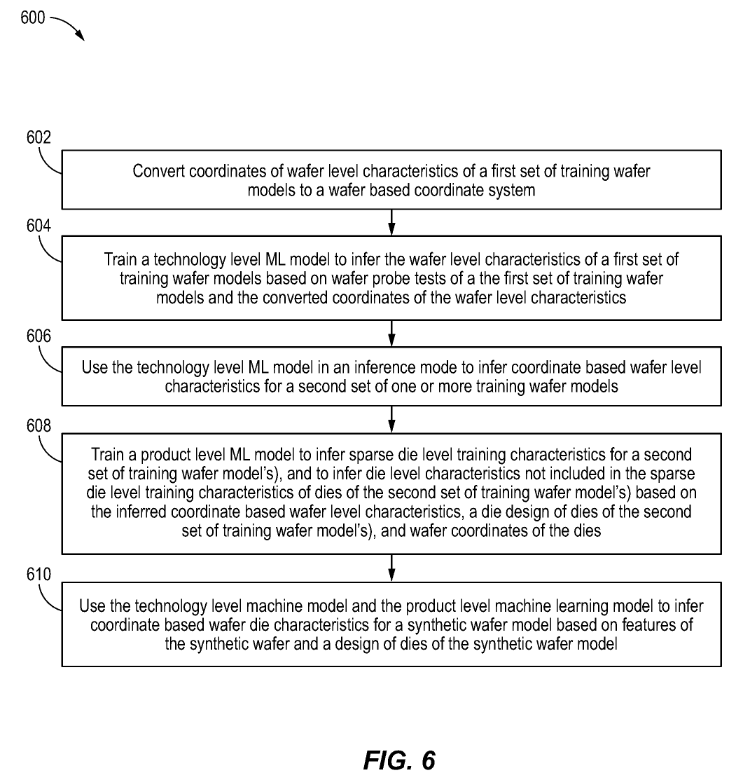

FIG. 3 depicts technology-level ML model 106 in a training mode, according to an embodiment. FIG. 4 depicts technology-level ML model 106 in an inference mode and product-level ML model 108 in a training mode, according to an embodiment. FIG. 5 depicts multi-tiered ML model 122 in an inference mode, according to an embodiment. FIGS. 3 through 5 are described below with reference to FIG. 6.

FIG. 6 depicts a method of training and using system 100, according to an embodiment. Method 600 is described below with reference to FIGS. 1 through 5. Method 600 is not, however, limited to the examples of FIGS. 1 through 5.

At 602, coordinate converter 134 converts test site coordinates 210 of test sites 202 to converted coordinates 212.

At 604, training system 120 trains technology-level ML model 106 to infer wafer-level training characteristics 208 obtained from multiple test sites 202 of multiple physical training wafer models 206 (FIG. 2A), based on features of the respective training wafers models 206 and converted test site coordinates 212. Training system 120 may train technology-level ML model 106 based on a supervised training method(s) and/or a generative training method(s). A generative training method(s) may be useful where wafer-level training characteristics 208 are incomplete (i.e., sparse).

At 606, training system 120 uses technology-level ML model 106 in an inference mode to infer coordinate-based wafer-level characteristics 404 (FIG. 4) for training wafer model(s) 226 (FIG. 2B).

At 608, training system 120 trains product-level ML model 108 (FIG. 4) to infer sparse die-level training characteristics 228 for training wafer model(s) 226 (FIG. 2B), and to infer die level characteristics not included in sparse die-level training characteristics 228 (e.g., due to test faults and/or other factors), based on inferred coordinate-based wafer-level characteristics 404, a die design 406 of dies 222 (FIG. 2B), and corresponding die coordinates 230. Training system 120 may train product-level ML model 108 based on a supervised machine learning method(s) and/or a generative training method(s). A generative training method(s) may be useful to compensate for sparse die-level training characteristics 228.

At 610, multi-tiered ML model 122 infers coordinate-based wafer/die level characteristics 102 for wafer model 104 (e.g., a proposed or synthetic wafer model), such as depicted in FIG. 5. In FIG. 5, technology-level ML model 106 infers coordinate-based wafer-level characteristics 110 based on features of wafer model 104, die design 112, and coordinates 502 of dies of wafer model 104. Multi-tiered ML model 122 may infer coordinate-based wafer/die level characteristics for additional wafer models (e.g., variations of wafer model 104).

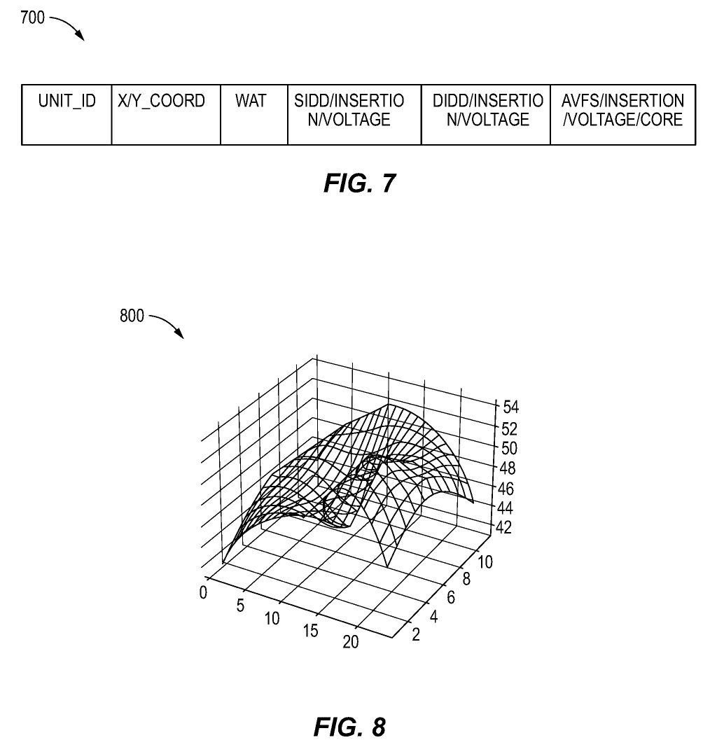

FIG. 7 depicts a table 700 of wafer-level and die-level characteristics, according to an embodiment.

FIG. 8 depicts a multi-dimensional plot 800 of coordinate-based die-level characteristics for dies of synthetic wafers, according to an embodiment.

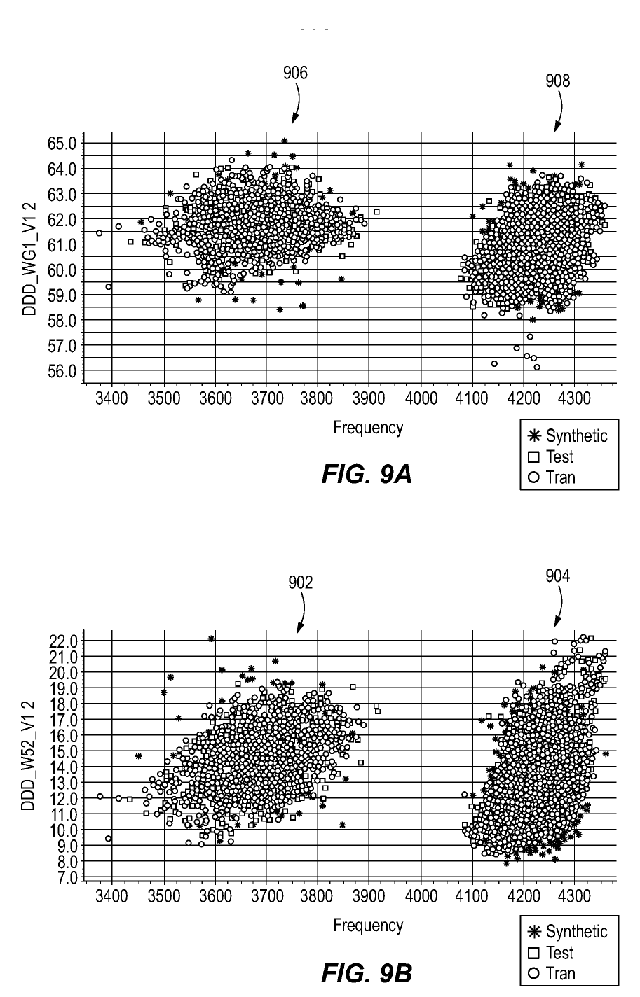

FIG. 9A depicts 2-dimensional plots 906 and 908 (i.e., clouds) of coordinate-based die-level characteristics for dies of synthetic wafers, according to an embodiment. FIG. 9B depicts 2-dimensional plots 902 and 904 of coordinate-based die-level characteristics for dies of synthetic wafers, according to an embodiment. In FIGS. 9A and 9B, the coordinate-based die-level characteristics include synthetic data, training data, and test/validation data. In plots 902 and 904, the vertical axis (i.e., y-axis) represents parametric measurements with cold temperature. In plots 906 and 908, the vertical axis (i.e., y-axis) represents the parametric measurements with hot temperature.

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An apparatus, comprising:
a processor and memory comprising instructions to cause the processor to:
receive wafer-level training characteristics for a first set of physical training wafers;
receive coordinates of wafer test sites from which the wafer-level training characteristics are obtained;
convert the coordinates of the wafer-level training characteristics from a coordinate system of a test probe to a wafer-based coordinate system;
train a technology-level machine learning (ML) model to infer the wafer-level training characteristics based on the converted coordinates;
use the technology-level ML model to infer coordinate-based wafer-level characteristics of a second set of physical training wafers;
receive sparse coordinate-based die-level training characteristics for dies of the second set of physical wafer models, wherein the sparse coordinate-based die-level training characteristics comprise die-level training characteristics for a subset of the dies of the second set of physical wafer models; and
train a product-level ML model to infer the sparse coordinate-based die-level training characteristics of the subset of dies of the second set of physical training wafer models and to infer coordinate-based die-level training characteristics for other dies of the second set of physical training wafers, based on the inferred coordinate-based wafer-level characteristics of the second set of physical training wafers, a design of the dies of the second set of physical training wafers, and coordinates of the dies of the second set of physical training wafers.

2. The apparatus of claim 1, wherein the instructions further cause the processor to:
train the product-level ML model to infer the coordinate-based die-level characteristics of the subset of dies of the second set of physical training wafer models and the remaining dies of the second set of physical training wafer models based on a combination of supervised learning and generative learning training methods.

3. The apparatus of claim 1, wherein the instructions further cause the processor to:
train the product-level ML model to infer the coordinate based die-level characteristics of the remaining dies of the second set of physical training wafer models based further on a K-nearest neighbors training method.

4. The apparatus of claim 1, wherein the instructions further cause the processor to train one or more of the technology-level ML model and the product-level ML model based on one or more of:
a tabular variational autoencoder using metric learning (TVAE) method;
a conditional tabular generative adversarial network (CTGAN) method; and
Gaussian Copulas.

5. The apparatus of claim 1, wherein the instructions further cause the processor to
train the technology-level ML model to model spatial variances in the coordinate-based wafer-level characteristics of the first set of physical training wafer models; and
train the product-level ML model to model spatial variances in the coordinate-based die-level characteristics of the second set of physical training wafers.

6. The apparatus of claim 1, wherein:
the coordinate-based wafer-level characteristics of the first set of physical training wafer models comprise one or more of wafer acceptance test data and data obtained from scribe line structures of the first set of physical training wafer models; and
the coordinate-based die-level characteristics of the second set of physical training wafer models comprise parametric test characteristics, including leakage and performance characteristics.

7. The apparatus of claim 1, wherein the instructions further cause the processor to:
use the technology-level ML model and the product-level model to infer coordinate-based die-level characteristics of dies of a synthetic wafer model based on features of the synthetic wafer model, a design of dies of the synthetic wafer model, and coordinates of the dies of the synthetic wafer model.

8. The apparatus of claim 1, wherein the instructions further cause the processor to:
use the technology-level ML model to infer coordinate-based wafer characteristics of a synthetic wafer model based on features of the synthetic wafer model; and
use the product-level ML model to infer coordinate-based die-level characteristics of the synthetic wafer model based on a design of dies of the synthetic wafer model, coordinates of the dies of the synthetic wafer model, and the inferred coordinate-based wafer-level characteristics of the synthetic wafer model.

9. The apparatus of claim 8, wherein:
the synthetic wafer model comprises a variation of the second set of physical wafer models.

10. A non-transitory computer readable medium encoded with a computer program that comprises instructions to cause a processor to:
infer coordinate-based wafer-level characteristics of a synthetic wafer model based on features of the synthetic wafer model and a technology-level machine-learning (ML) model; and
infer coordinate-based die-level characteristics of the synthetic wafer model based on the inferred wafer-level characteristics of the synthetic wafer model, a design of dies of the synthetic wafer model, and a product-level ML model;
wherein one or more of the technology-level ML model and the product-level ML model is trained based on sparse training data based in part on a generative training method.

11. The non-transitory computer readable medium of claim 10, wherein the instructions further cause the processor to:
receive wafer-level training characteristics for a first set of physical training wafers;
receive coordinates of wafer test sites from which the wafer-level training characteristics are obtained;
convert the coordinates of the wafer-level training characteristics from a coordinate system of a test probe to a wafer-based coordinate system;
train a technology-level machine learning (ML) model to infer the wafer-level training characteristics based on the converted coordinates;
use the technology-level ML model to infer coordinate-based wafer-level characteristics of a second set of physical training wafers; and
receive sparse coordinate-based die-level training characteristics for dies of the second set of physical wafer models, wherein the sparse coordinate-based die-level training characteristics comprise die-level training characteristics for a subset of the dies of the second set of physical wafer models; and
train a product-level ML model to infer the sparse coordinate-based die-level training characteristics of the subset of dies of the second set of physical training wafer models and to infer coordinate-based die-level training characteristics for other dies of the second set of physical training wafers, based on the inferred coordinate-based wafer-level characteristics of the second set of physical training wafers, a design of the dies of the second set of physical training wafers, and coordinates of the dies of the second set of physical training wafers.

12. The non-transitory computer readable medium of claim 11, wherein:
the coordinate-based wafer-level training characteristics comprise one or more of wafer acceptance test parameters and characteristics obtained from scribe line structures; and
the coordinate-based die-level training characteristics comprise parametric test characteristics, including leakage and performance characteristics.

13. The non-transitory computer readable medium of claim 11, wherein the instructions further cause the processor to:
train the product-level ML model to infer the coordinate-based die-level characteristics of the subset of dies of the second set of physical training wafer models and the remaining dies of the second set of physical training wafer models based on a combination of supervised learning and generative learning training methods.

14. The non-transitory computer readable medium of claim 11, wherein the instructions further cause the processor to:
train the product-level ML model to infer the coordinate based die-level characteristics of the remaining dies of the second set of physical training wafer models based further on a K-nearest neighbors training method.

15. The non-transitory computer readable medium of claim 11, wherein the instructions further cause the processor to train one or more of the technology-level ML model and the product-level ML model based on one or more of:
a tabular variational autoencoder using metric learning (TVAE) method;
a conditional tabular generative adversarial network (CTGAN) method; and
Gaussian Copulas.

16. The non-transitory computer readable medium of claim 11, wherein the instructions further cause the processor to:
train the technology-level ML model to model spatial variances in the coordinate-based wafer-level characteristics of the first set of physical training wafer models; and
train the product-level ML model to model spatial variances in the coordinate-based die-level characteristics of the second set of physical training wafers.

17. The non-transitory computer readable medium of claim 11, wherein:
the coordinate-based wafer-level characteristics of the first set of physical training wafer models comprise one or more of wafer acceptance test data and data obtained from scribe line structures of the first set of physical training wafer models; and
the coordinate-based die-level characteristics of the second set of physical training wafer models comprise parametric test characteristics, including leakage and performance characteristics.

18. A method, comprising:
receiving wafer-level training characteristics for a first set of physical training wafers;
receiving coordinates of wafer test sites from which the wafer-level training characteristics are obtained;
converting the coordinates of the wafer-level training characteristics from a coordinate system of a test probe to a wafer-based coordinate system;
training a technology-level machine learning (ML) model to infer the wafer-level training characteristics based on the converted coordinates;
using the technology-level ML model to infer coordinate-based wafer-level characteristics of a second set of physical training wafers;
receiving sparse coordinate-based die-level training characteristics for dies of the second set of physical wafer models, wherein the sparse coordinate-based die-level training characteristics comprise die-level training characteristics for a subset of the dies of the second set of physical wafer models; and
training a product-level ML model to infer the sparse coordinate-based die-level training characteristics of the subset of dies of the second set of physical training wafer models and to infer coordinate-based die-level training characteristics for other dies of the second set of physical training wafers, based on the inferred coordinate-based wafer-level characteristics of the second set of physical training wafers, a design of the dies of the second set of physical training wafers, and coordinates of the dies of the second set of physical training wafers.

19. The method of claim 18, wherein the training the product-level ML model comprises:
training the product-level ML model to infer the coordinate-based die-level characteristics of the subset of dies of the second set of physical training wafer models and the remaining dies of the second set of physical training wafer models based on a combination of supervised learning and generative learning training methods.

20. The method of claim 18, further comprising:
using the technology-level ML model to infer coordinate-based wafer characteristics of a synthetic wafer model based on features of the synthetic wafer model; and
using the product-level ML model to infer coordinate-based die-level characteristics of the synthetic wafer model based on a design of dies of the synthetic wafer model, coordinates of the dies of the synthetic wafer model, and the inferred coordinate-based wafer-level characteristics of the synthetic wafer model.
